(19) United States
(12) Patent Application Publication
(10) Pub. No.: US 2010/0189289 A1
(43) Pub. Date: Jul. 29, 2010

(54) CAPACITOR MICROPHONE CHIP, CAPACITOR MICROPHONE, AND MANUFACTURING METHOD THEREOF

(76) Inventor: Yusuke Takeuchi, Kanagawa (JP)

Correspondence Address: MCDERMOTT WILL & EMERY LLP, 600 13TH STREET, NW, WASHINGTON, DC, 20005-3096, US

(21) Appl. No.: 12/305,775

(22) PCT Filed: Jun. 27, 2007
(86) PCT No.: PCT/JP2007/062947

§ 371 Date: Dec. 19, 2008

(30) Foreign Application Priority Data
Jun. 29, 2006 (JP) 2006-179359
Jun. 29, 2006 (JP) 2006-179360

(51) Int. Cl. H04R 1/00; H04R 31/00

(52) U.S. Cl. 381/174; 29/594

(57) ABSTRACT

An object of the invention is to design microminiaturization and higher sensitivity of a capacitor microphone chip formed by micromachining a silicon substrate and a wafer is diced so that a silicon substrate of a microphone chip is shaped almost like a hexagon, preferably a regular hexagon, and a back air chamber is shaped like a circle or a regular hexagon.

### TECHNICAL FIELD

This invention relates to a capacitor microphone chip, a capacitor microphone, and a manufacturing method thereof and in particular to dicing of a capacitor microphone substrate manufactured using a silicon wafer.

### BACKGROUND ART

An electret capacitor microphone (ECM) is an electroacoustic transducer with an electret film placed on one electrode of a capacitor for giving a charge to the electret film and detecting capacity change of the capacitor varying according to the sound pressure of a sound wave as an electric signal. Attention is focused on the electret capacitor microphone as a small-sized electroacoustic transducer eliminating the need for DC bias of a capacitor by using an electret film having semipermanent polarization.

As a conventional ECM is configured so as to assemble mechanical parts by inserting them into a metal case and seal the metal case by metal working method called curling and thus many ECMs are formed like a cylindrical shape to facilitate caulking.

Under these circumstances, in recent years, an art (MEMS technology) of forming a microminiaturized capacitor microphone only using a semiconductor process by micromachining a silicon substrate rather than forming a capacitor microphone by assembling mechanical parts has been proposed (for example, patent documents 1, 2, and 3).

The capacitor microphone of silicon manufactured using the manufacturing technology of MEMS (Micro Electro Mechanical System) elements is called “silicon microphone (or silicon mike)” and in recent years, particular attention has been focused as a manufacturing technology of an ECM to install in a mobile telephone terminal, etc., with miniaturization and slimming down moving forward.

The silicon microphone is manufactured by working a silicon substrate using the semiconductor process technology, as described above. Therefore, usually, element formation is performed on a silicon wafer and then the silicon wafer is divided into silicon microphone chips by dicing the silicon wafer and thus each silicon microphone chip is formed as a quadrangle.

By the way, the effective portion actually vibrating and contributing to mike sensitivity, of a vibration membrane on a silicon substrate is determined by the shape of an area of the silicon substrate cut from the back thereof and exposed, namely, the shape of a back air chamber. From the viewpoint of the sensitivity, to enlarge the vibration membrane, the back air chamber is formed as a quadrangle and the effective portion of the vibration membrane is formed as a quadrangle. Further, one reason why the back air chamber is formed as a quadrangle is that anisotropic wet etching of one of silicon working methods can be used. (For example, refer to patent document 6.)

There is also an example wherein a circular back air chamber is formed by dry etching silicon on a quadrangular silicon substrate for enhancing the vibration characteristic.

In patent document 4, a method of forming a capacitor without working a silicon substrate and forming the shape of one like a regular polygon is conducted.

In a dicing step, instead of conventional cutting with a dicing blade, an art relevant to a laser beam machining method of entering a laser beam with a converging point set to the inside of a wafer, forming a modified region by multiphoton absorption in the wafer inside, and dividing the wafer into chips is proposed (for example, patent document 5).

By the way, the acoustic sensitivity of an ECM is calculated according to the following expression:

The acoustic sensitivity is proportional to the area of a vibration membrane and is inversely proportional to the natural frequency.

As in the art described in patent document 6, when the back air chamber is formed as a quadrangle, the vibration membrane is supported on the top of the back air chamber and thus the vibration mode becomes a quadrangle vibration mode. At this time, if the membrane areas are the same, the natural frequency of the membrane of the quadrangle becomes higher than that of a circle and the sensitivity becomes lower.

However, when the back air chamber is formed as a circle on a quadrangle silicon substrate as in the art described in patent document 3, if the area of the quadrangle silicon substrate is the same, the area of the circular back air chamber that can be formed becomes smaller than the area of the quadrangular back air chamber that can be formed and the sensitivity becomes lower.

Hitherto, as any other chip shape than the quadrangle, a hexagon, a polygon more than the hexagon, or a circle has been proposed to disperse the thermal contraction stress or the thermal expansion stress in resin sealing and prevent a package crack (refer to patent document 7).

That is, considering the yield in the step of cutting semiconductor chips from a semiconductor wafer by dicing, the circle involves a large fruitless region and a low yield. In fact, there is also a problem of misalignment in a drawing step for dicing, and it is difficult to satisfy both sufficient workability and yield in the configuration.

Patent document 1: JP-A-11-88992

Patent document 2: JP-A-2005-20411 (FIG. 1)

Patent document 3: International Patent Publication No. 2000-508860 (FIG. 1A, FIG. 1B)

Patent document 4: JP-A-2001-231099 (FIG. 10, 11)

Patent document 5: JP-A-2002-192367

Patent document 6: JP-A-2002-27595 (paragraph numbers [0030] to [0035], FIG. 1, FIG. 3)

Patent document 7: JP-A-5-101997

### DISCLOSURE OF THE INVENTION

### Problems To Be Solved By the Invention

Thus, if the back air chamber is shaped like a circle, the vibration mode becomes a circle vibration mode and higher sensitivity can be designed as compared with the quadrangular back air chamber.

However, if the silicon substrate is a quadrangle, considering the size in which a circular back air chamber can be formed, it is impossible to form a sufficiently large circular back air chamber; this is a problem.

To actually dice a silicon wafer to form capacitor microphone chips, if any other shape than the quadrangle is adopted, a redundant region is produced and reduction in yields is incurred and in addition, actual dicing is extremely difficult to perform; this is a problem.

Particularly, to form a circular chip, all the circumference of the circle becomes a dicing line and it is necessary to draw a dicing line in surroundings of the chips. Working is extremely difficult to perform, misalignment easily occurs, and production workability is poor; this is a problem. Particularly, for a structure wherein a recess part of a back air chamber, etc., is formed from the back of a silicon substrate, slight misalignment causes not only the characteristic to be degraded, but also a crack to easily occur and the manufacturing yield drastically reduces; this is a problem.

The invention is embodied considering the actual circumstances described above and it is an object of the invention to design microminiaturization and higher sensitivity of a capacitor microphone chip formed by micromachining a silicon substrate.

It is also an object of the invention to provide a manufacturing method of a capacitor microphone chip excellent in productivity as degradation of yield is prevented.

### Means For Solving the Problems

To accomplish the objects mentioned above, in the invention, a wafer is diced so that a silicon substrate of a microphone chip is shaped almost like a hexagon, preferably a regular hexagon, and a back air chamber is shaped like a circle or a regular hexagon.

That is, the invention provides a capacitor microphone chip wherein a vibration membrane as a movable electrode and a fixed electrode opposed to the vibration membrane through an air gap and having a sound hole are formed on a silicon substrate, wherein a part of the silicon substrate is removed so as to expose the back of the vibration membrane to form a back air chamber, and wherein the silicon substrate is shaped almost like a regular hexagon. According to the configuration, the silicon substrate is formed as a regular hexagon and thus the chips can be formed on a silicon wafer in a state in which they are placed without a gap by closet packing. Therefore, the wafer can be divided along dicing lines, so that productivity improves. Since every edge is an obtuse angle, occurrence of stress strain is more decreased.

At the time of the wafer dicing, because of a state in which each sides is rotated 120 degrees, the dicing is made possible by performing laser drawing three times by shifting 120 degrees at a time.

The invention includes the capacitor microphone chip described above wherein the back air chamber is formed as the center of the silicon substrate is cut like a circle.

According to the configuration, the vibration mode of the vibration membrane can be made a circle and higher sensitivity can be designed.

The invention includes the capacitor microphone chip described above wherein the back air chamber is formed as the center of the silicon substrate is cut like a regular hexagon.

According to the configuration, good area rate, miniaturization, and higher sensitivity can be designed. Preferably, the outer shape and the corresponding side of the back air chamber are made parallel, whereby the area rate can be more increased and it is made possible to design higher sensitivity.

The invention includes the capacitor microphone chip described above wherein the back air chamber is formed as the center of the silicon substrate is cut like a polygon.

According to the configuration, it is made possible to more improve the area rate.

The invention provides a capacitor microphone mounting any of the capacitor microphone chips described above.

According to the configuration, it is made possible to provide a small-sized and high-sensitivity capacitor microphone.

The invention provides a manufacturing method including the steps of forming a multilayer film which will become a vibration membrane on a surface of a silicon wafer; forming a fixed electrode through a sacrificial layer on the multilayer film; executing anisotropic etching until the vibration membrane is exposed from the back of the silicon wafer and forming a plurality of recess part forming a back air chamber; executing etching removal of the sacrificial layer to form an air gap; and dicing the silicon wafer to chips each almost like a regular hexagon so as to have the recess part at the center to form capacitor microphone chips each having a hexagonal shape.

According to the configuration, efficient dicing can be accomplished and it is made possible to provide a high-sensitivity capacitor microphone chip while enhancing yield.

The invention includes the manufacturing method of the capacitor microphone described above wherein the dicing step includes a first drawing step of performing laser drawing of the length corresponding to the length of one side of the capacitor microphone chip with a spacing of the length twice the length of one side in a first direction forming one side of the capacitor microphone chip by performing on/off control of a laser; a second drawing step of performing laser drawing of the length corresponding to the length of one side of the capacitor microphone chip with a spacing of the length twice the length of one side so that the end point of the one side and the start point in the drawing match in a second direction having an angle of 120 degrees with respect to the first direction by performing on/off control of the laser; and a third drawing step of performing laser drawing of the length corresponding to the length of one side of the capacitor microphone chip with a spacing of the length twice the length of one side so that the end point of the one side and the start point in the drawing match so as to have an angle of 120 degrees with respect to the second direction by performing on/off control of the laser.

According to the configuration, laser drawing can be accomplished extremely easily and it is made possible to perform dicing efficiently.

The invention includes the manufacturing method of the capacitor microphone described above including the step of forming a thin part by etching in the region where dicing is to be performed prior to the dicing step.

According to the configuration, the dicing is facilitated. As the thin part is formed, it can also be used for positioning for later laser drawing, and the dicing is also facilitated. If later laser drawing is not performed, a hexagonal chip can be easily formed by previously forming the thin part by etching.

The invention includes the manufacturing method of the capacitor microphone described above wherein the step of forming the thin part is a step of forming a continuous linear groove throughout the region where dicing is to be performed.

According to the configuration, more reliable dicing can be accomplished as compared with discontinuous lines.

### Advantages of the Invention

The capacitor microphone chip of the invention makes it possible to enhance the acoustic sensitivity of a capacitor microphone chip formed by machining a silicon substrate by a micromachining method and to provide a high-efficiency and high-reliability capacitor microphone chip.

According to the invention, it is made possible to provide a higher-sensitivity capacitor microphone chip when the chip area is constant.

Further, when the acoustic sensitivity is the same, the chip area can be lessened.

### BRIEF DESCRIPTION OF THE DRAWINGS

FIG. 1 is a perspective view of a silicon microphone chip of a first embodiment of the invention.

FIG. 2 is a top view of the silicon microphone chip of the first embodiment of the invention.

FIG. 3 is a sectional view of the silicon microphone chip of the first embodiment of the invention.

FIG. 4 is a sectional view of a device to describe the structure of the silicon microphone chip of the first embodiment of the invention manufactured by micromachining a silicon substrate.

FIG. 5 is a sectional view to show the packaging structure of an electret microphone using a silicon substrate (the structure after case sealing).

FIG. 6 is a comparison drawing to describe the relationship between the silicon substrate size and the back air chamber size.

FIG. 7 is a layout drawing on a silicon wafer.

FIG. 8 is a examplary representation to show a manufacturing process of the silicon microphone chip of the first embodiment of the invention.

FIG. 9 is a drawing to explain a dicing method.

FIG. 10 is a perspective view of a silicon microphone chip of a second embodiment of the invention.

FIG. 11 is a top view of the silicon microphone chip of the second embodiment of the invention.

FIG. 12 is a sectional view of the silicon microphone chip of the second embodiment of the invention.

FIG. 13 is a drawing to explain the relationship between the silicon substrate size and the back air chamber size.

FIG. 14 is a schematic representation to show a manufacturing process of a silicon microphone chip of a third embodiment of the invention.

### DESCRIPTION OF REFERENCE NUMERALS

31 Fixed electrode

32 Dielectric film (inorganic dielectric film)

33 Vibration film electrode (vibration film)

34 Silicon substrate (silicon diaphragm)

35 Sound hole (opening) provided in fixed electrode

36 Air gap formed by etching sacrificial layer

41 Shield case

42 Plastic or ceramic mount substrate

43 Semiconductor chip (silicon microphone chip) using silicon substrate

44 (44a, 44b) Bonding wire

45 (45a, 45b) Electronic component (FET, resistor, amplifier, etc.)

46 Ground pattern

47 Mike signal output pattern

49 Sound hole (opening) of mike package

L1, L2 Wiring in mount substrate

### BEST MODE FOR CARRYING OUT THE INVENTION

Next, embodiments of the invention is described in detail with reference to the accompanying drawings.

### Embodiments

Embodiments of the invention will be discussed with reference to the accompanying drawings.

### First Embodiment

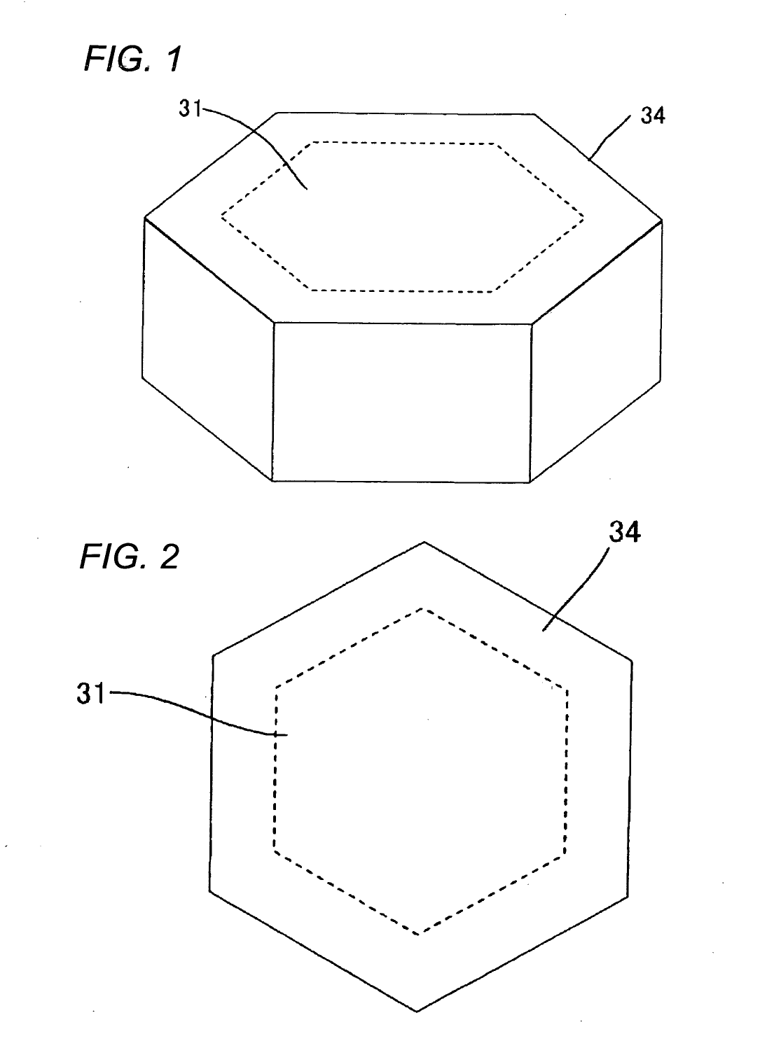

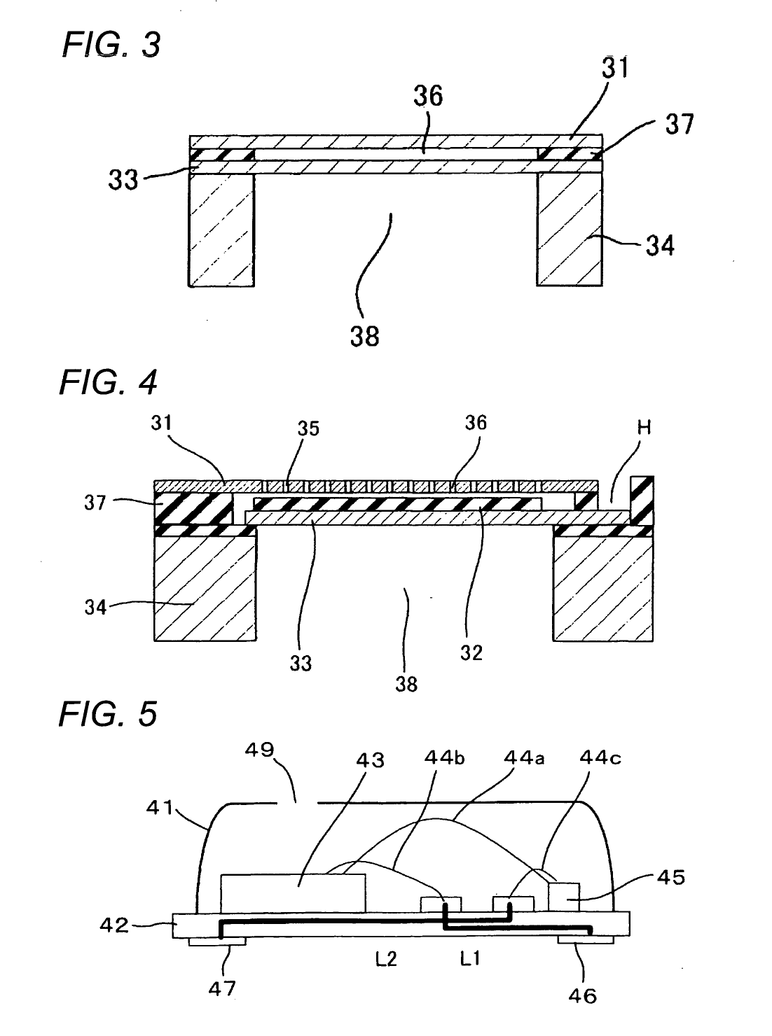

FIGS. 1 to 5 show a capacitor microphone of an embodiment of the present invention. FIGS. 1 to 3 are a perspective view, a top view, and a sectional view to describe the shape of a capacitor microphone chip of the embodiment of the invention manufactured by micromachining a silicon substrate. FIGS. 4 and 5 are cross-sectional schematic representations of a silicon microphone chip of the embodiment of the invention and an electret microphone in which the silicon microphone chip is installed.

In the embodiment, a silicon microphone chip 43 shaped like a regular hexagon shown in FIGS. 1 to 4 is installed on a mount substrate 42 and is electrically connected by a wire bonding method and is housed in a shield case 41, as shown in FIG. 5. As shown in FIG. 1, a fixed electrode 31 is formed like a hexagon formed so as to become concentric with the silicon microphone chip 43 (silicon substrate 34) and parallel with each sides of the silicon microphone chip and although not shown, a through hole of the same shape so as to be opposed to the fixed electrode is formed from the back of the silicon microphone chip 43, forming a back air chamber 38. Other points of the structure are formed so as to form a usual structure.

The silicon microphone chip 43 has the silicon substrate 34, a vibration membrane 33 made of a polycrystalline silicon film formed on the surface of the silicon substrate for functioning as one pole of a capacitor, a silicon oxide film as an inorganic dielectric film 32 as an electret film (film to be converted into an electret), a spacer part 37 made of a silicon oxide film, the fixed electrode 31 functioning as an another pole of the capacitor, and the back air chamber 38 formed by etching the silicon substrate 34, as shown in FIG. 4. The fixed electrode 31 is provided with a plurality of sound holes (openings for introducing a sound wave into the vibration membrane 33) 35. Reference numeral 36 denotes an air gap and H denotes a contact hole for electric connection.

The vibration membrane 33, the fixed electrode 31, and the inorganic dielectric film 32 are manufactured by using the micromachining technology of silicon and the manufacturing process technology of a CMOS (complementary field-effect transistor), so called components of MEMS elements.

FIG. 5 is a sectional view to show the package structure of the electret microphone using a silicon substrate (the structure after case sealing). Parts common to those in FIGS. 1 to 4 are denoted by the same reference numerals in FIG. 5. In FIG. 5, the silicon microphone (semiconductor device) chip 43 is described in a simplified manner (the actual structure is as shown in FIG. 4).

As shown in FIG. 5, the silicon microphone (semiconductor device) chip 43 and electronic components (FET, resistors, amplifier, etc.,) 45 of miscellaneous elements are mounted on the mount substrate 42 having a plastic or ceramic multilayer interconnection structure.

A ground pattern 46 and a mike signal output pattern 47 are placed on the back of the mount substrate 42. The silicon microphone chip 43 is mounted on the mount substrate 42 as shown in FIG. 5. The vibration membrane 33 forming one pole of the capacitor is connected to the miscellaneous electronic component 45 through a bonding wire 44a from the contact hole H provided in the insulating film forming the spacer part 37. Further, the electronic components 45 are electrically connected to a wiring pattern 60b on the mount substrate 42 through a bonding wire 44c. The fixed electrode 31 forming an another pole of the capacitor is connected to a wiring pattern 60a on the mount substrate through a bonding wire 44b. The wiring patterns 60a and 60b are electrically connected to the ground pattern 46 and the mike signal output pattern 47 provided on the back of the mount substrate 42 through wiring L1 and wiring L2 in the mount substrate. FIG. 5 schematically shows using arrows for easy understanding of the flow of the electric connection.

The shield case 41 is attached onto the mount substrate 42 after electret conversion processing is completed. The shield case 41 is provided with a wide opening 49 as a sound hole for introducing a sound wave.

The silicon substrate 34 is a regular hexagon and the back air chamber 38 is also formed in a regular hexagon.

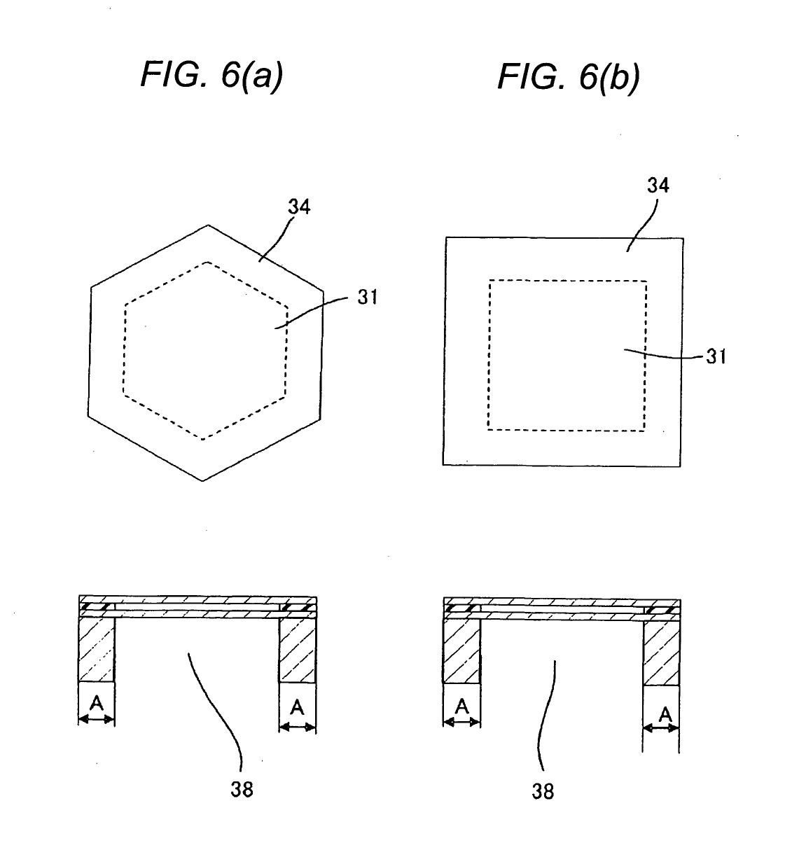

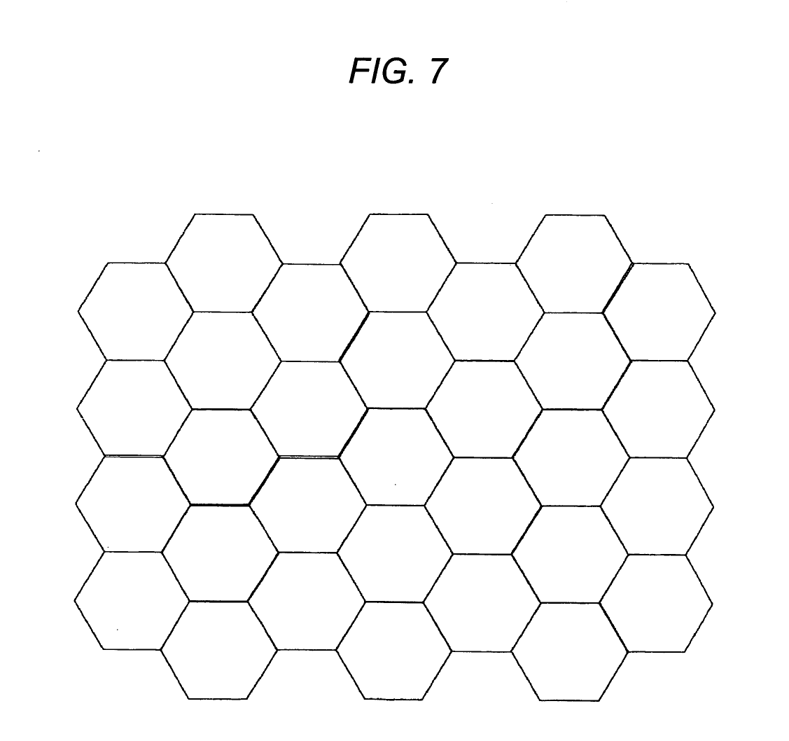

FIG. 6 is a drawing to describe the relationship between the silicon substrate size and the back air chamber size. The vibration membrane 33 exposed to the upper part of the back air chamber 38 is an effective portion for vibration of the vibration membrane.

FIG. 6 (a) shows the case where the shape of the silicon substrate 34 is a hexagon and the shape of the back air chamber 38 is also a hexagon, and FIG. 6 (b) shows the case where the shape of the silicon substrate 34 is a quadrangle and the shape of the back air chamber 38 is also a quadrangle in the related art. If the areas of the silicon substrates in (a) and (b) are the same and further a width A of a frame surrounding the back air chamber in the bottom of the silicon substrate 34 in (a) is the same as that in (b), the effective area for vibration of the vibration membrane 33 defined by the top of the back air chamber 38 in (a) is larger about 5% than that in (b). Further, the natural frequency of the vibration membrane of a hexagon is lower about 5% than that of a quadrangle if the areas are the same.

The sensitivity in (a) is higher about 10% than that in (b) according to the two effects described above.

FIG. 7 is a layout drawing of capacitor microphone chips on a silicon wafer. Regular hexagons can be arranged without a gap as same as in the case where quadrangles are arranged, and no fruitless portion is produced. For example, if the chip is a regular octagon, 30% of the wafer area becomes fruitless; if the chip is a circle, 25% of the wafer area becomes fruitless in addition to the impossibility of linear dicing.

Next, a manufacturing method of the capacitor microphone chips, particularly a dicing method to manufacture the capacitor microphone chips is described.

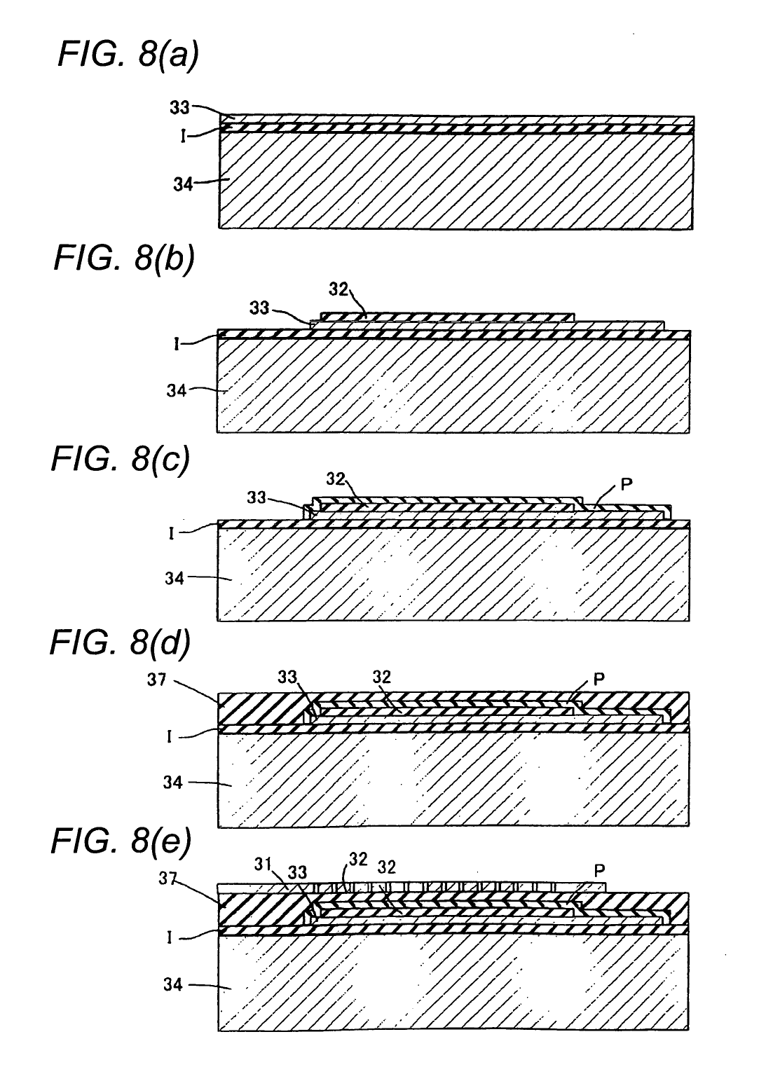

To begin with, a polycrystalline silicon film to form a vibration membrane 33 is formed through an insulating film I such as a silicon oxide film on a silicon wafer surface to form a silicon substrate 34, as shown in FIG. 8 (a).

Subsequently, a silicon oxide film to form an electret film 32 is deposited in order and then they are patterned, as shown in FIG. 8 (b). At this time, the vibration membrane and the electret film 32 are patterned so as to form regular hexagons.

Subsequently, a silicon nitride film as a passivation film P is formed so as to cover the vibration membrane 33 and the silicon oxide film forming the electret film 32, as shown in FIG. 8 (c).

Subsequently, a silicon oxide film (BPSG film) 37 which will become a sacrificial layer to form an air gap 36 and a spacer is formed and then a polycrystalline silicon layer to form a fixed electrode 31 is formed and is patterned by photolithography as shown in FIG. 8 (d) and sound holes 35 are formed as shown in FIG. 8 (e). An etchant is supplied from the sound holes 35, whereby the silicon oxide film below the sound holes 35 is etched to form the air gap 36 (sacrificial layer). At this time, the passivation film P formed so as to cover the vibration membrane 33 and the silicon oxide film forming the electret film 32 acts as an etching stopper, and the air gap is formed. At this time, a portion where the sound hole 35 does not exist is not etched and is left and acts as the spacer 37.

Although not shown, before the sacrificial layer is etched, etching is performed from the back side of the silicon substrate using the polycrystalline silicon layer as the vibration membrane 33 as an etching stopper to form a back air chamber 38.

Last, a contact hole H (see FIG. 4) for wire bonding is formed.

The silicon wafer on which element regions are thus formed is diced using a laser, whereby it is divided into silicon microphone chips.

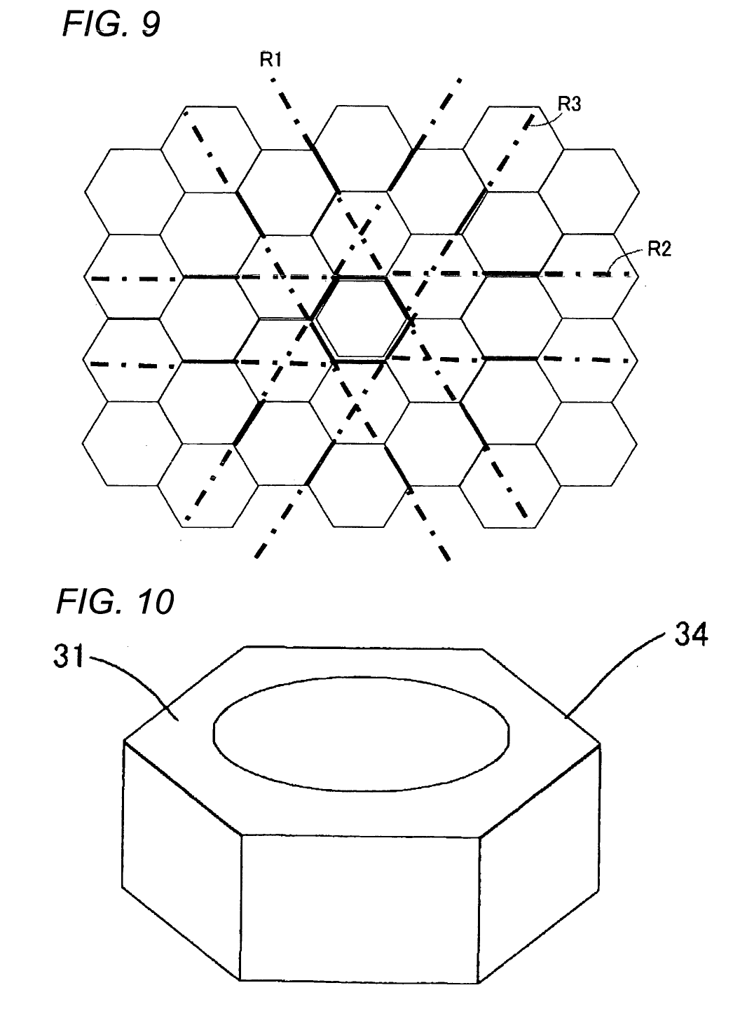

In the dicing, to begin with, a first laser drawing region R1 is formed by performing laser drawing of the length corresponding to the length of one side of the capacitor microphone chip with a spacing of the length twice the length of one side in a first direction forming one side of the capacitor microphone chip by performing on/off control of the laser (first drawing step), as shown in FIG. 9.

Subsequently, a second laser drawing region R2 is formed by performing laser drawing of the length corresponding to the length of one side of the capacitor microphone chip with a spacing of the length twice the length of one side so that the end point of the one side and the start point in the drawing match in a second direction having an angle of 120 degrees with respect to the first direction by performing on/off control of the laser (second drawing step), as shown in FIG. 9.

Last, a third laser drawing region R3 is formed by performing laser drawing of the length corresponding to the length of one side of the capacitor microphone chip with a spacing of the length twice the length of one side so that the end point of the one side and the start point in the drawing match in a third direction having an angle of 120 degrees with respect to the second direction by performing on/off control of the laser (third drawing step), as shown in FIG. 9.

Thus, according to the dicing method of the invention, laser drawing is performed parallelly in three times alignment, whereby dicing can be accomplished extremely easily and efficiently. Since the chips can be formed without producing any fruitless wafer area, the yield is extremely high as almost 100%.

In the method of the first embodiment, since the hexagon chips are spread and packed as shown in FIG. 7, blade dicing as usual cannot be executed. Thus, the method of cutting the silicon wafer using a laser is used. A laser beam is scanned along the lines indicated by R1, R2, and R3 in FIG. 9 and further laser radiation is turned on and off at given time intervals. Adjustment is made so as to cut only the solid line portions shown in FIG. 9, whereby the silicon capacitor chips can be formed so as to form a regular hexagon extremely easily and with good workability and it is made possible to provide high-sensitivity capacitor microphone chip.

### Second Embodiment

Next, a second embodiment of the invention will be discussed.

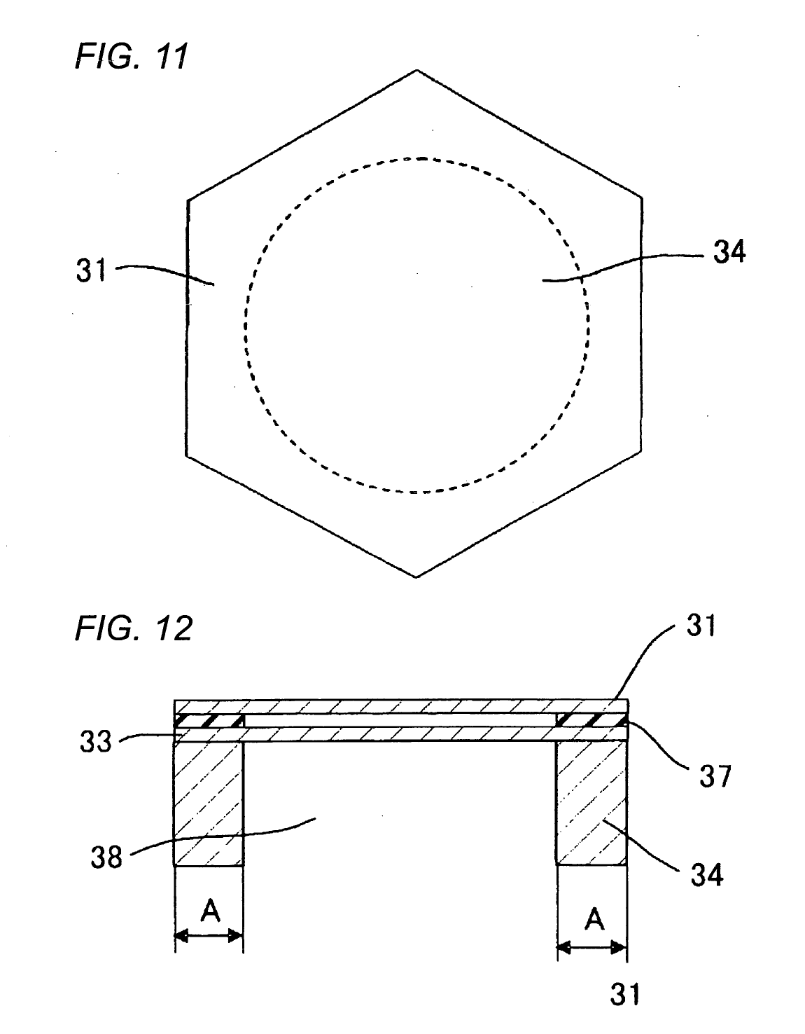

FIGS. 10, 11, and 12 are a perspective view, a top view, and a sectional view to describe the shape of a capacitor microphone chip of the invention.

In the first embodiment, the capacitor microphone chip is formed as a regular hexagon and the back air chamber is also formed as a regular hexagon formed concentrically; the second embodiment is characterized by the fact that a silicon substrate 34 forming a capacitor microphone chip is a regular hexagon and a back air chamber 38 is formed like a circle. Other parts are formed like those of the first embodiment.

FIG. 12 is a drawing to describe the relationship between the silicon substrate size and the back air chamber size. The shape of the effective portion for vibration of a vibration membrane 33 is defined by the shape of the upper port of the back air chamber 38.

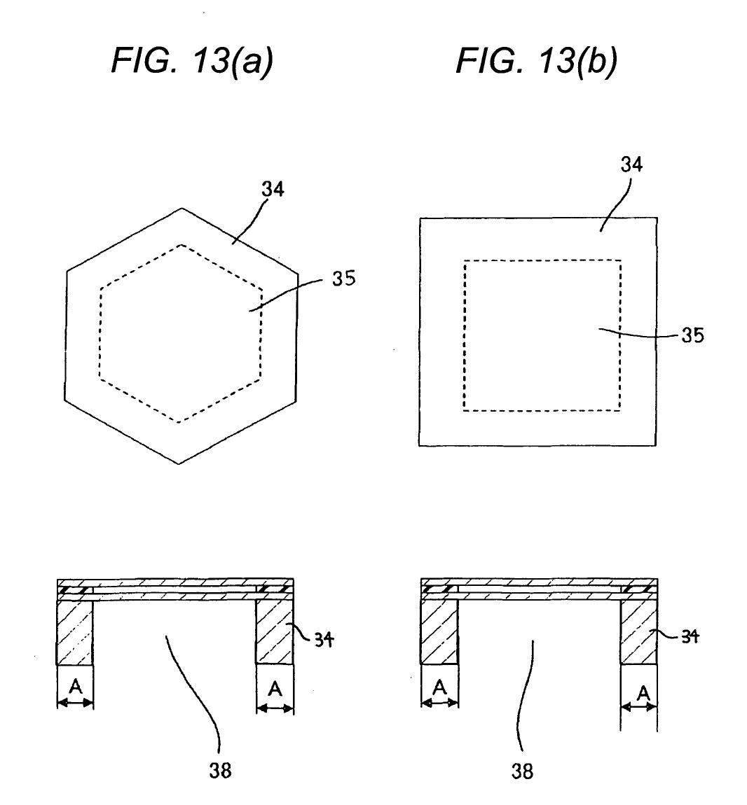

FIG. 13 (a) is a schematic representation to show the case where the shape of the silicon substrate 34 is a hexagon and the shape of the back air chamber 38 is a circle, and FIG. 13 (b) shows the case where the shape of the silicon substrate 34 is a quadrangle and the shape of the back air chamber 38 is also a quadrangle in the related art.

As is obvious from the comparison between (a) and (b), if the silicon substrate sizes in (a) and (b) are the same and further a width A of a frame in (a) is the same as that in (b), the effective area for vibration of the vibration membrane 33 defined by the upper part of the back air chamber 38 in (a) is larger about 10% than that in (b). Further, the natural frequency of the vibration membrane of a circle is lower about 10% than that of a quadrangle if the areas are the same.

Therefore, according to the structure, the regular hexagon in (a) provides sensitivity as much as that of the quadrangle in (b), but the manufacturing yield of the circle is better.

### Third Embodiment

Next, a modified example of the manufacturing method of the capacitor microphone chip is described.

In the first embodiment, a BPSG film is used as the sacrificial layer and the air gap is formed so as to leave the spacer by entry of an etchant from the sound holes; in a third embodiment, an example of using a resist as a sacrificial layer will be discussed.

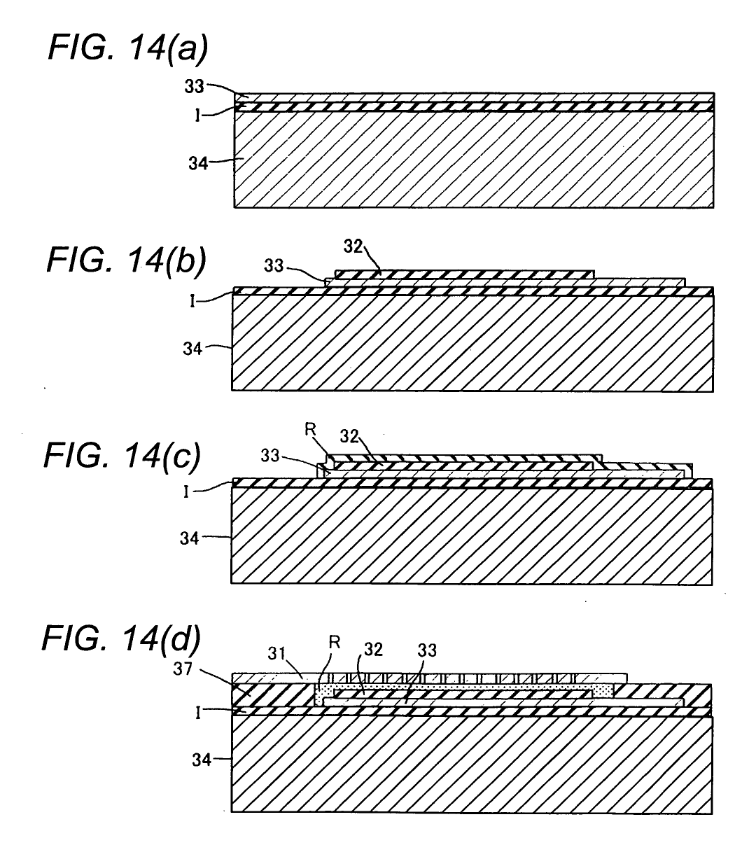

To begin with, a polycrystalline silicon film to form a vibration membrane 33 is formed through an insulating film I such as a silicon oxide film on a silicon wafer surface to form a silicon substrate 34, as shown in FIG. 14 (a).

Subsequently, a silicon oxide film to form an electret film 32 is deposited in order and then they are patterned, as shown in FIG. 14 (b). At this time, the vibration membrane and the electret film 32 are patterned so as to form regular hexagons. A resist is applied to the top layer to form a sacrificial layer R.

Subsequently, sacrificial layer R to form an air gap 36 is formed, as shown in FIG. 14 (c). Then, a silicon oxide film 37 to be a spacer is formed and then a polycrystalline silicon layer to form a fixed electrode 31 is formed and is patterned by photolithography and sound holes 35 are formed as shown in FIG. 8 (d). When the resist used in the patterning step of the polycrystalline silicon layer is peeled, the sacrificial layer R is removed and the air gap 36 is formed.

After that, a contact hole H (see FIG. 4) for wire bonding is formed.

Although not shown, before the sacrificial layer is removed to form the air gap, etching is performed from the back side of the silicon substrate using the polycrystalline silicon layer as the vibration membrane 33 as an etching stopper to form a back air chamber 38.

The silicon wafer thus formed with element regions is diced using a laser, whereby it is divided into silicon microphone chips.

In the first to third embodiments described above, the silicon wafer is diced using a laser, whereby it is divided into silicon microphone chips, but before laser drawing, a thin part may be formed by etching in the region where laser drawing is to be performed or the region where dicing is to be performed.

According to the configuration, the dicing is facilitated. As the thin part is formed, it can also be used for positioning for later laser drawing, and the dicing is also facilitated.

As a method of dicing to a hexagonal shape, a thin part may be formed by etching without using laser drawing.

According to the configuration, hexagonal chips can also be formed easily. The etching may be performed at the same time as the etching step to form the back air chamber. In this case, perforated or discontinuous grooves rather than a continuous groove are desirable for maintaining the strength. The etching timing is not limited to the time of forming the back air chamber and before the element region is formed, a thin part may be formed in a region where later dicing is executed.

To form a thin part, a continuously linear groove part may be formed throughout the region where dicing is executed.

A continuously linear groove part is formed, whereby more reliable dicing can be accomplished as compared with discontinuous lines.

In addition, the invention is also effective for completion to mounting using a technique of mounting capacitor microphone chips at the wafer level and dicing the wafer, namely, wafer level CSP; after mounting, the wafer is diced to hexagonal chips by a method of laser drawing, etc., whereby it is made possible to form a capacitor microphone of the chip size.

In the embodiments, formation of the capacitor microphone has been described, but higher sensitivity can also be designed in other devices of an acceleration sensor, a pressure sensor, etc., and the invention is effective, needless to say.

That is, when a semiconductor substrate of a silicon substrate, etc., is diced, the invention can also provide a dicing method capable of producing a high yield and performing highly accurate dicing.

The invention can also provide a small-sized, high-yield, and high-reliability semiconductor device.

The following method is also effective:

A manufacturing method of a semiconductor device of the invention including a dicing step of dividing a semiconductor wafer into semiconductor chips after desired element regions are formed on the semiconductor wafer wherein the dicing step includes a first drawing step of performing laser drawing of the length corresponding to the length of one side of the semiconductor chip with a spacing of the length twice the length of one side in a first direction forming one side of the semiconductor chip by performing on/off control of a laser; a second drawing step of performing laser drawing of the length corresponding to the length of one side of the semiconductor chip with a spacing of the length twice the length of one side so that the end point of the one side and the start point in the drawing match in a second direction having an angle of 120 degrees with respect to the first direction by performing on/off control of the laser; and a third drawing step of performing laser drawing of the length corresponding to the length of one side of the semiconductor chip with a spacing of the length twice the length of one side so that the end point of the one side and the start point in the drawing match so as to have an angle of 120 degrees with respect to the second direction by performing on/off control of the laser.

According to the method, laser drawing is performed three times by shifting 120 degrees at a time, whereby dicing is made possible and thus laser drawing can be accomplished extremely easily and it is made possible to perform dicing efficiently. Also, as a state in which each sides rotate each 120 degrees, efficient dicing can be performed so that the semiconductor chips are shaped each like a regular hexagon, and the semiconductor chips can be placed and formed on a semiconductor wafer in a state in which they are placed without a gap by closet packing. The semiconductor wafer can be thus divided along dicing lines forming regular hexagons, so that productivity improves. Since every edge is an obtuse angle, occurrence of stress strain is more decreased and it is made possible to provide a high-reliability semiconductor device without incurring degradation of yield.

The invention includes the manufacturing method of the semiconductor device described above wherein the first to third drawing steps are steps of performing collective drawing a plurality of lines using laser heads arranged like a line spaced from each other with a spacing of the length of one side.

According to the configuration, in alignment three times, it is made possible to extremely easily perform dicing with good productivity and high accuracy.

The invention includes the manufacturing method of the semiconductor device described above wherein the first to third drawing steps are steps of shifting by the length of one side for each line and drawing so as to form parallel lines.

According to the configuration, it is made possible to draw with good workability using one head.

The invention includes the manufacturing method of the semiconductor device described above including the step of rotating a laser head 120 degrees before executing the second drawing step after the first drawing step.

According to the configuration, drawing with extremely high accuracy is made possible simply by rotating the laser head.

The invention includes the manufacturing method of the semiconductor device described above including the step of rotating a laser head 120 degrees before executing the third drawing step after the second drawing step.

According to the configuration, drawing with extremely high accuracy is made possible simply by rotating the laser head.

The invention includes the manufacturing method of the semiconductor device described above including the step of etching from the back side of the semiconductor wafer to form a thin region partially prior to the dicing step.

Although the thin region and a dicing line need to be aligned, according to the configuration, it is made possible to easily perform alignment with good workability.

The invention includes the manufacturing method of the semiconductor device described above wherein the thin region becomes a vibration part in the semiconductor device.

According to the configuration, high-accuracy and high-reliability shape working can be performed, so that it is made possible to provide a high-accuracy and high-reliability semiconductor device.

The invention includes the manufacturing method of the semiconductor device described above wherein the semiconductor device is an MEMS microphone.

According to the configuration, it is made possible to provide a high-reliability MEMS microphone.

The invention includes the manufacturing method of the semiconductor device described above wherein the semiconductor device is an MEMS filter.

According to the configuration, it is made possible to provide a high-reliability MEMS filter.

The invention includes a semiconductor device manufactured by the manufacturing method of the semiconductor device described above.

The invention includes the semiconductor device described above wherein the semiconductor device forms a capacitor microphone chip including a vibration membrane as a mobile electrode and a fixed electrode opposed to the vibration membrane with an air gap between and having a sound hole on a silicon substrate forming almost a regular hexagon, wherein a part of the silicon substrate is removed so as to expose the back of the vibration membrane to form a back air chamber.

According to the configuration, it is made possible to provide a high-accuracy and high-reliability capacitor microphone chip.

The invention includes the semiconductor device described above wherein the semiconductor device includes a vibration membrane and a fixed electrode opposed to the vibration membrane with an air gap between on a silicon substrate forming almost a regular hexagon, wherein a part of the silicon substrate is removed so as to expose the back of the vibration membrane.

According to the configuration, the best area rate, miniaturization, and higher sensitivity can be designed. Preferably, the outer shape and the corresponding side of the back air chamber are made parallel, whereby the area rate can be more increased and it is made possible to design higher sensitivity.

In the manufacturing method of the semiconductor device of the invention, laser drawing is performed three times by shifting 120 degrees at a time, whereby dicing of a semiconductor wafer is made possible and thus laser drawing can be accomplished extremely easily and it is made possible to perform dicing efficiently. A state in which the sides of each chip rotate each 120 degrees is entered, efficient dicing can be performed so that the semiconductor chips are shaped each like a regular hexagon, and the semiconductor chips can be placed and formed on a semiconductor wafer in a state in which they are placed without a gap by closest packing. The semiconductor wafer can be thus divided along dicing lines forming regular hexagons, so that productivity is improved. Since every edge is an obtuse angle, occurrence of stress strain is more decreased and it is made possible to provide a high-reliability semiconductor device without incurring degradation of yield.

As the semiconductor device of the invention, for example, it is made possible to enhance the acoustic sensitivity of a capacitor microphone chip formed by machining a silicon substrate by a micromachining method and provide a high-efficiency and high-reliability capacitor microphone chip.

According to the invention, it is made possible to provide a higher-sensitivity capacitor microphone chip when the chip area is constant.

Further, when the acoustic sensitivity is the same, the chip area can be lessened.

### INDUSTRIAL APPLICABILITY

The invention produces the advantage that higher sensitivity in the same area is achieved in a silicon microphone chip using a semiconductor chip formed by micromachining a silicon substrate, and is useful as a microminiaturized silicon microphone installed in a mobile communication machine, a component microphone chip of the silicon microphone, and an apparatus used for manufacturing it.

1. A capacitor microphone chip wherein a vibration membrane as a movable electrode and a fixed electrode provided so as to be opposed to the vibration membrane with an air gap therebetween and having a sound hole are formed on a silicon substrate, and a back air chamber is formed by removing a part of the silicon substrate so as to expose a back side of the vibration membrane, wherein
the silicon substrate is shaped almost like a regular hexagon.

2. The capacitor microphone chip according to claim 1 wherein
the back air chamber is formed as the center of the silicon substrate is cut like a circle.

3. The capacitor microphone chip according to claim 1 wherein
the back air chamber is formed as the center of the silicon substrate is cut almost like a regular hexagon.

4. The capacitor microphone chip according to claim 1 wherein
the back air chamber is formed as the center of the silicon substrate is cut like a polygon.

5. A capacitor microphone mounting a capacitor microphone chip according to any of claims 1 to 4.

6. A manufacturing method of the capacitor microphone chip according to any of claims 1 to 4, said manufacturing method comprising the steps of:
forming a multilayer film to be a vibration membrane on a surface of a silicon wafer;
forming a fixed electrode through a sacrificial layer on the multilayer film;
executing anisotropic etching until the vibration membrane is exposed from a back side of the silicon wafer and forming a plurality of recess part forming a back air chamber;
executing etching removal of the sacrificial layer to form an air gap; and
dicing the silicon wafer to substantially hexagonal shape so as to have the recess part at the center and to form capacitor microphone chip having a hexagonal shape.

7. The manufacturing method of the capacitor microphone according to claim 6 wherein said dicing step comprises:
a first drawing step of performing laser drawing of the length corresponding to the length of one side of the capacitor microphone chip with a spacing of the length twice the length of one side in a first direction forming one side of the capacitor microphone chip by performing on-off control of a laser;
a second drawing step of performing laser drawing of the length corresponding to the length of one side of the capacitor microphone chip with a spacing of the length twice the length of one side so that the end point of the one side and the start point in the drawing match in a second direction having an angle of 120 degrees with respect to the first direction by performing on-off control of the laser; and
a third drawing step of performing laser drawing of the length corresponding to the length of one side of the capacitor microphone chip with a spacing of the length twice the length of one side so that the end point of the one side and the start point in the drawing match so as to have an angle of 120 degrees with respect to the second direction by performing on-off control of the laser.

8. The manufacturing method of the capacitor microphone according claim 6 or 7 comprising the step of:
forming a thin part by etching in the region where dicing is to be performed prior to said dicing step.

9. The manufacturing method of the capacitor microphone according to claim 8 wherein
the step of forming the thin part is a step of forming a continuous linear groove throughout the region where dicing is to be performed.
